(19) United States
(12) Patent Application Publication
(10) Pub. No.: US 2014/0007168 A1
(43) Pub. Date: Jan. 2, 2014

(54) METHOD AND APPARATUS FOR EXTENDING RECEIVING RANGE OF BROADCAST PROGRAM

(71) Applicant: ELECTRONICS AND TELECOMMUNICATIONS RESEARCH INSTI, Daejeon-si (KR)

(72) Inventors: Han Seung KOO, Daejeon-si (KR); Young Kwon HAHM, Daejeon-si (KR); Dong Joon CHOI, Daejeon-si (KR)

(73) Assignee: ELECTRONICS AND TELECOMMUNICATIONS RESEARCH INSTITUTE, Daejeon-si (KR)

(21) Appl. No.: 13/685,623

(22) Filed: Nov. 26, 2012

(30) Foreign Application Priority Data
Jul. 2, 2012 (KR) 10-2012-0071625

(51) Int. Cl. H04N 21/61

(52) U.S. Cl. CPC H04N 21/6106
USPC 725/81

(57) ABSTRACT

The present invention relates to broadcast communication and, more particularly, to a method and apparatus for enabling a terminal capable of receiving mobile broadcast, such as DMB, to additionally receive a broadcast program provided by cable/IPTV/satellite broadcast. A broadcast receiver detects an idle band using a CR method, sends at least one of information about a broadcast channel and information about the idle band to a terminal, receives information that requests to provide a specific broadcast channel of one or more broadcast channels, included in information about a broadcast channel, from the terminal, receives the one or more broadcast channels from a broadcast station, selects the specific broadcast channel from the broadcast channels based on the information requesting to provide the specific broadcast channel, transfers the selected broadcast channel to a mobile broadcast delivery unit, and delivers mobile broadcast for the specific broadcast channel on the idle band.

Priority to Korean patent application number 10-2012-0071625 filed on Jul. 2, 2012, the entire disclosure of which is incorporated by reference herein, is claimed.

### BACKGROUND OF THE INVENTION

1. Field of the Invention

The present invention relates to broadcast communication and, more particularly, to a method and apparatus for enabling a terminal capable of receiving mobile broadcast, such as Digital Multimedia Broadcasting (DMB), to additionally receive a broadcast program provided by cable/IPTV/satellite broadcast.

2. Discussion of the Related Art

With the development of broadcast and communication, more various broadcast channels could have been provided through a variety of media. The number of users who receive mobile broadcast service through which desired broadcast programs can be viewed anywhere while moving by using mobile terminals, such as portable phones, Personal Digital Assistants (PDAs), and smart phones, is increasing. The number of broadcast channels, such as cable/IPTV/satellite broadcast, is increasing, but users who own terminals through which mobile broadcast, such as DMB, can be received inevitably receive only a limited number of broadcast channels and programs delivered by mobile broadcast stations.

In order to solve this inconvenience, there is suggested a method of transferring a large number of channels and programs provided by broadcasting companies which provide services, such as cable/IPTV/satellite broadcast, to users using communication employing a wireless Internet method, such as WiFi. If multi-channel broadcast, such as cable/IPTV/satellite broadcast, is provided in a physically narrow area, such as a home or a specific building, however, the above wireless Internet method is problematic in that it may not provide smooth service because a high load is generated in a transmission network when a plurality of concentrated users views a plurality of channels.

### SUMMARY OF THE INVENTION

An object of the present invention is to provide a method and apparatus for enabling a user to view a variety of channels and programs delivered by broadcasting companies which provide services, such as cable/IPTV/satellite broadcast, using a terminal capable of receiving mobile broadcast.

Another object of the present invention is to provide a method and apparatus for delivering mobile broadcast using a Cognitive Radio (CR) method.

Yet another object of the present invention is to provide a method and apparatus for receiving a variety of channels and programs through mobile broadcast.

### BRIEF DESCRIPTION OF THE DRAWINGS

The accompany drawings, which are included to provide a further understanding of this document and are incorporated on and constitute a part of this specification illustrate embodiments of this document and together with the description serve to explain the principles of this document.

FIG. 1 shows an example in which a broadcast receiver having a mobile broadcast delivery function mounted thereon according to the present invention receives broadcasting from a broadcast station and delivers the broadcasting to a terminal having a mobile broadcast reception function;

FIG. 2 is a flowchart illustrating a procedure in which the terminal having the mobile broadcast reception function receives common broadcast content, such as cable/IPTV/satellite broadcast, in accordance with an embodiment of the present invention;

FIG. 3 shows an example of a method of allocating a mobile broadcast delivery idle band based on a CR method in accordance with the present invention;

FIG. 4 is a flowchart illustrating an operation in which the terminal stops the delivery of mobile broadcast by sending information, indicating that the reception of a mobile broadcast signal has ended, to the broadcast receiver in accordance with an embodiment of the present invention;

FIG. 5 is a flowchart illustrating an operation in which the broadcast receiver stops the delivery of mobile broadcast by operating a timer in accordance with another embodiment of the present invention;

FIG. 6 an example of an operation in which a remote access apparatus requests the broadcast receiver to record a broadcast program in accordance with an embodiment of the present invention;

FIG. 7 shows an example of an operation in which the terminal requests the broadcast receiver to delivery mobile broadcast for a recorded broadcast program and receives the recorded broadcast program in accordance with an embodiment of the present invention;

FIG. 8 shows another example of the operation in which the terminal requests the broadcast receiver to deliver mobile broadcast for a recorded broadcast program and receives the recorded broadcast program in accordance with an embodiment of the present invention;

FIG. 9 shows an example of an operation in which the remote access apparatus requests a broadcast station to record a broadcast program in accordance with an embodiment of the present invention;

FIG. 10 is a block diagram of the broadcast receiver configured to deliver mobile broadcast in accordance with an embodiment of the present invention; and

FIG. 11 is a block diagram of the terminal configured to receive mobile broadcast in accordance with an embodiment of the present invention.

### DETAILED DESCRIPTION OF THE EMBODIMENTS

Hereinafter, some exemplary embodiments of the present invention are described in detail with reference to exemplary drawings. It is to be noted that in assigning reference numerals to respective elements in the drawings, the same reference numerals designate the same elements although the elements are shown in different drawings. Furthermore, in describing the embodiments of the present invention, a detailed description of known functions and constructions is omitted if it is deemed to make the gist of the present invention unnecessarily vague.

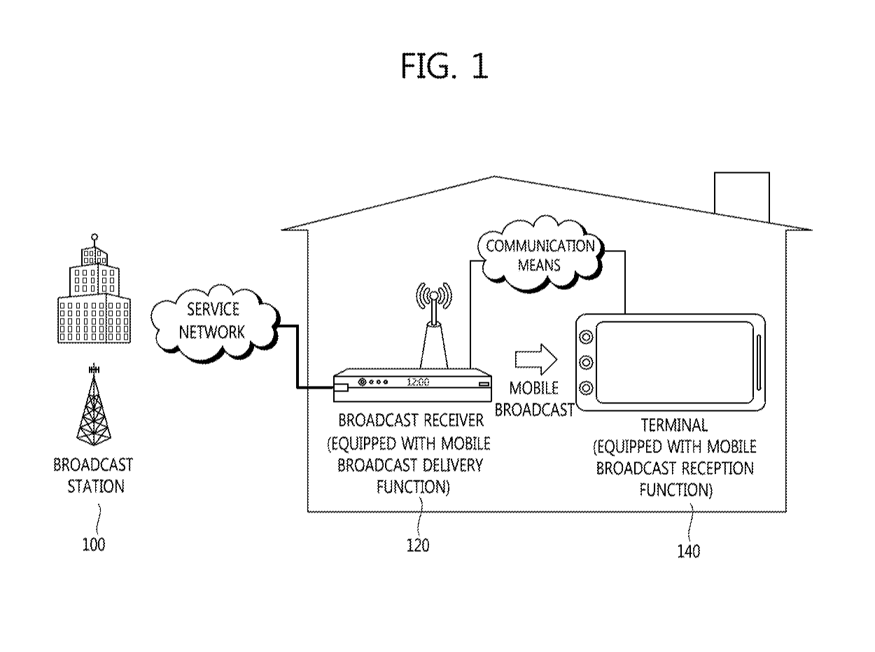

FIG. 1 shows an example in which a broadcast receiver having a mobile broadcast delivery function mounted thereon according to the present invention receives broadcasting from a broadcast station and delivers the broadcasting to a terminal having a mobile broadcast reception function.

Referring to FIG. 1, a broadcast station 100 delivers pieces of broadcast content, provided by cable/IPTV/satellite broadcast, over a service network. For example, the service network may be a broadcast network over which broadcast content is provided through broadcast service or an Internet Protocol (IP) network over which broadcast content is provided through Internet service.

A broadcast receiver 120 receives the pieces of broadcast content delivered by the broadcast station 100. That is, the broadcast receiver 120 may receive one or more broadcast channels from the broadcast station 100. The broadcast receiver 120 may be, for example, TV or a set top box.

The broadcast receiver 120 may deliver mobile broadcast. The mobile broadcast may be delivered with low output. In this case, the mobile broadcast may also be called low-output mobile broadcast. Here, the mobile broadcast can be received by a mobile terminal, and a user can view a desired broadcast program anywhere while moving through the mobile broadcast. Furthermore, the low output broadcast means broadcast that is provided within a limited area (i.e., a small-sized area) using low output signal. When the broadcast receiver 120 delivers the mobile broadcast with low output, the broadcast receiver 120 can transfer broadcast content, received from the broadcast station 100, to a terminal 140 while minimizing external interference.

The broadcast receiver 120 may detect and monitor an idle frequency band (hereinafter referred to as an ‘idle band’) in which mobile broadcast can be delivered, such as TV white space, using a Cognitive Radio (CR) method. Here, the CR method is technology for searching for an idle frequency band that is not used depending on an area and time and enabling desired wireless communication while protecting surrounding authorized radio stations. The broadcast receiver 120 using a CR method according to an embodiment searches for idle spectra which are scattered in various widths and whose occupation times continue to change, determines a frequency bandwidth, output, and a modulation method suitable for a corresponding environment, and reuses the delivery of mobile broadcast, thereby being capable of improving the efficiency of limited frequency resources.

The broadcast receiver 120 may be connected to the terminal 140 through communication means (e.g., wired/wireless Internet, Bluetooth) which is connected thereto in a wired or wireless manner and configured to be able to perform bidirectional communication. The broadcast receiver 120 may send at least one of information about an idle band and information about a broadcast channel through which mobile broadcast will be delivered to the terminal 140 through the communication means. Furthermore, the broadcast receiver 120 may receive information that requests to provide a specific broadcast channel of one or more broadcast channels, included in information about a broadcast channel, from the terminal 140 through the communication means. In this case, in response to the request of the information that requests to provide the specific broadcast channel, the broadcast receiver 120 may select the specific broadcast channel from the one or more broadcast channels and deliver mobile broadcast for the specific broadcast channel on the idle band.

The terminal 140 has a mobile broadcast reception function. That is, the terminal 140 may receive a specific broadcast channel or mobile broadcast for a broadcast program which is delivered by the broadcast receiver 120.

Furthermore, the terminal 140 may be connected to broadcast receiver 120 through the communication means. The terminal 140 may receive at least one of the information about an idle band and information about a broadcast channel on which the broadcast receiver 120 wants to send mobile broadcast through the communication means. The terminal 140 may generate information that requests to provide a specific broadcast channel of one or more broadcast channels included in the received information about a broadcast channel and send the generated information to the broadcast receiver 120 through the communication means. In some embodiments, the terminal 140 may send information that requests to record a specific broadcast program and information that requests to provide the specific recorded broadcast program to the broadcast receiver 120 through the communication means. The terminal 140 may receive mobile broadcast for the specific broadcast channel or mobile broadcast for the specific recorded broadcast program within a distance where the mobile broadcast delivered by the broadcast receiver 120 may be received.

Exemplary operations of the broadcast station 100, the broadcast receiver 120, and the terminal 140 are described in detail below.

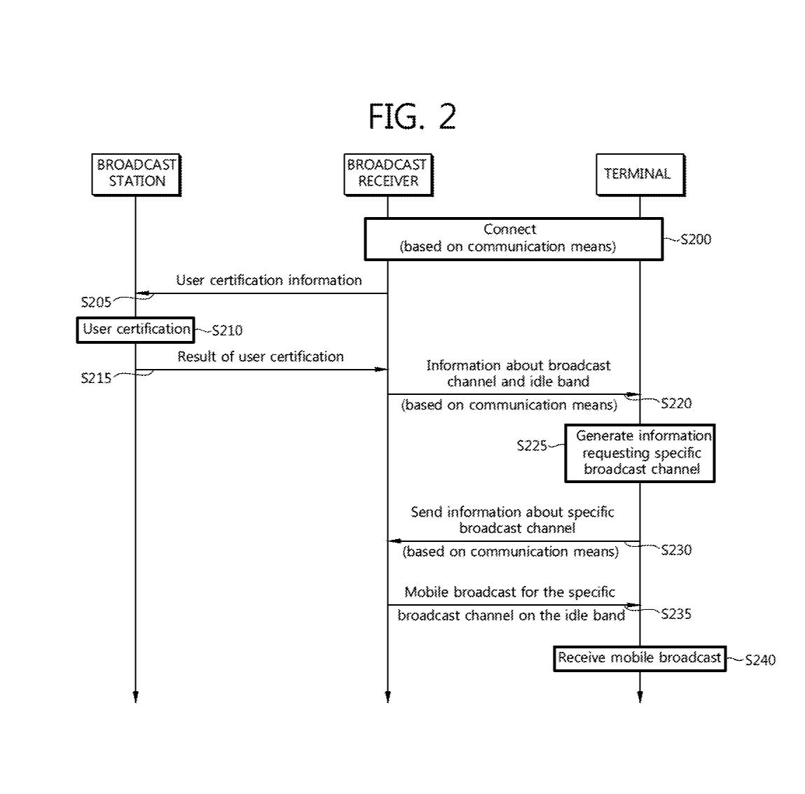

FIG. 2 is a flowchart illustrating a procedure in which the terminal having the mobile broadcast reception function receives common broadcast content, such as cable/IPTV/satellite broadcast in accordance with an embodiment of the present invention.

Referring to FIG. 2, the terminal is connected to the broadcast receiver through communication means (e.g., wired/wireless Internet, Bluetooth) which is connected thereto in a wired or wireless manner and configured to be able to perform bidirectional communication at step S200. Here, the terminal first requests to connect to the broadcast receiver. If user certification is necessary according to the content distribution policy of the broadcast station, the terminal may transfer user certification information (e.g., an ID and a password) to the broadcast receiver. For example, IPTV may send broadcasting content using a multicast method. In this multicast method, several users can receive the broadcasting content through one transmission if there are several users in the same network. Accordingly, a user who has not subscribed to the same network is prevented from accessing the broadcasting content based on the user certification.

If user certification is not necessary according to the content distribution policy of the broadcast station, the steps S205 to S215 may not be performed and the process directly proceeds to step S220. If user certification is necessary according to the content distribution policy of the broadcast station, the broadcast receiver transfers the user certification information, obtained at step S200, to the broadcast station at step S205. Here, a necessary transfer method and return channel may be implemented in various ways depending on the broadcast station.

The broadcast station performs user certification based on the user certification information at step S210. The broadcast station may determine whether a corresponding user is an authorized user for broadcast service provided by the broadcast station or not based on the user certification. Furthermore, the broadcast station may provide a different broadcast channel and different service depending on a user based on a result of the user certification. In some embodiments, the broadcast station may determine whether the user may use mobile broadcast through the broadcast receiver of the broadcast content, provided by the broadcast station, based on the user certification. Furthermore, if the broadcast station limits the number of broadcast channels and the type of broadcast channel which may be delivered through the mobile broadcast, from among pieces of broadcasting content provided by the broadcast station, differentially depending on a user (e.g., a broadcast channel delivered through mobile broadcast through the broadcast receiver depending on a fee), the user certification may include information about whether the user can use the mobile broadcast through the broadcast receiver and information about broadcast channels that may be provided to the user.

Next, the broadcast station transfers a result of the user certification to the broadcast receiver at step S215.

If, a result of the user certification, the user is an authorized user for the broadcasting content provided by the broadcast station (or the user is a user who can use the mobile broadcast) or if user certification is not necessary according to the content distribution policy of the broadcast station (i.e., when the steps S205 to S215 are omitted), the broadcast receiver sends at least one of information about a broadcast channel and information about an idle band to the terminal through the communication means, connected to the terminal at step S200, at step S220. Here, information about a broadcast channel may be basically information about a channel schedule that is provided by the broadcast station. In some embodiments, if channels that may be provided by the broadcast receiver are limited depending on a user at step S210, information about a broadcast channel may be information about a channel that may be provided by the broadcast receiver. Furthermore, the information about an idle band is obtained by the broadcast receiver using a CR method, the idle band is a band on which the broadcast receiver will deliver the mobile broadcast, and the terminal uses the idle band when performing Radio Frequency (RF) tuning.

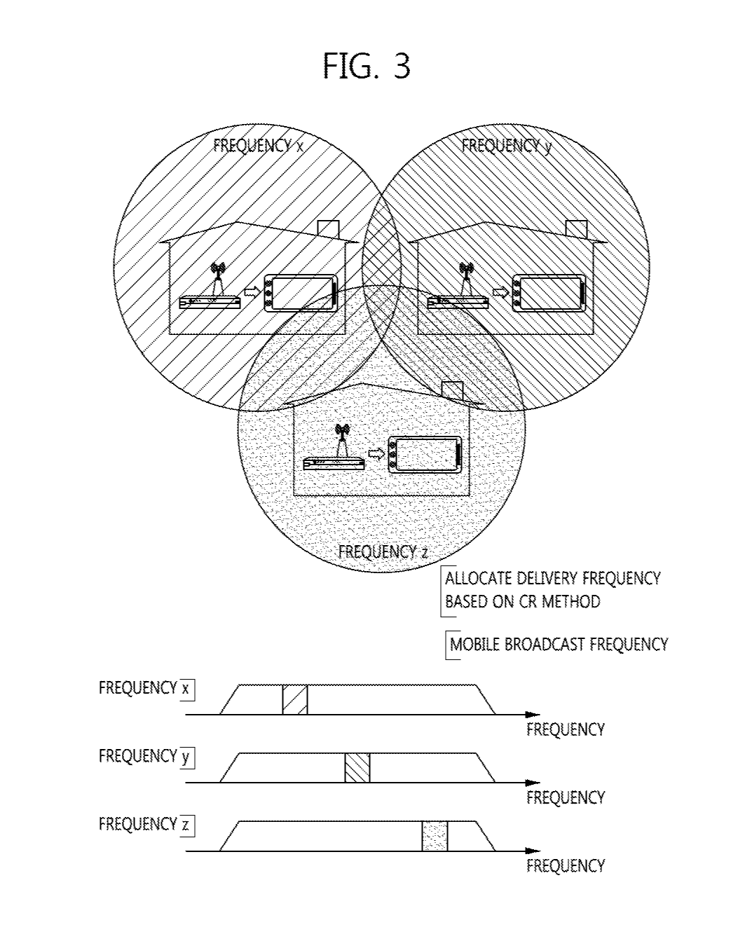

FIG. 3 shows an example of a method of allocating a mobile broadcast delivery idle band based on a CR method in accordance with the present invention. Referring to FIG. 3, there are a frequency x, a frequency y, and a frequency z as idle bands. If the frequency x and the frequency y are already being used by another neighbor broadcast receiver, interference between the frequencies may occur when the terminal uses the frequency x and the frequency y. Accordingly, the broadcast receiver sends information about a frequency z to the terminal. Thus, the terminal may receive mobile broadcast for a desired channel through the frequency z. In some embodiments, the broadcast receiver may inform the terminal of information about a frequency x, the frequency y, and the frequency z and inform the terminal that the frequency x and the frequency y are already being used by another neighboring broadcast receiver. If the number of available frequencies is plural, the broadcast receiver may send information about a specific one of the plurality of available frequencies to the terminal or may give priority to the plurality of frequencies and send information about all the frequencies to the terminal.

Referring back to FIG. 2, the terminal selects a specific broadcast channel based on information about a broadcast channel and generates information that requests to provide the specific broadcast channel at step S225. The terminal sends the information that requests to provide the specific broadcast channel to the broadcast receiver through the communication means at step S230.

The broadcast receiver delivers mobile broadcast for the specific broadcast channel on the idle band at step S235.

The terminal operates in a mobile broadcast reception mode and receives the mobile broadcast, delivered by the broadcast receiver, on the idle band at step S240. The terminal may output the specific broadcast channel using audio and video output means based on the mobile broadcast.

If the terminal selects another broadcast channel while receiving the mobile broadcast for the specific broadcast channel, the terminal may receive another broadcast channel by performing steps starting from step S225.

Meanwhile, if the broadcast receiver continues to deliver the mobile broadcast even when the terminal terminates the reception of the mobile broadcast, it may be inefficient in terms of the frequency and power. In this case, it is necessary for the broadcast receiver to stop the delivery of the mobile broadcast. This may be performed as follows.

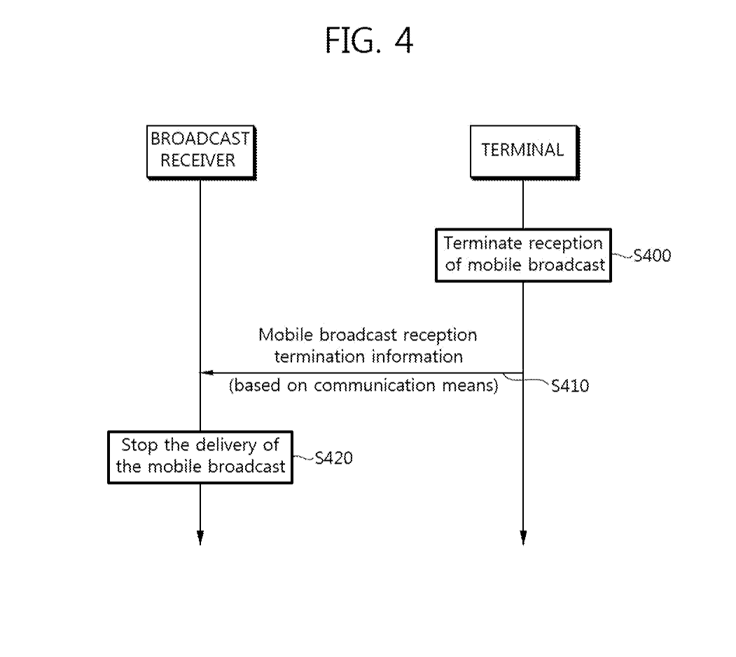

FIG. 4 is a flowchart illustrating an operation in which the terminal stops the delivery of mobile broadcast by sending information, indicating that the reception of a mobile broadcast signal has ended, to the broadcast receiver in accordance with an embodiment of the present invention. FIG. 4 illustrates an example in which the reception of mobile broadcast for a specific broadcast channel has been terminated, but the operation of FIG. 4 may also be applied to the case where the reception of mobile broadcast for a specific recorded broadcast program has been terminated.

Referring to FIG. 4, the terminal terminates the reception of mobile broadcast from the broadcast receiver at step S400.

The terminal generates mobile broadcast reception termination information, indicating that the terminal has terminated the reception of the mobile broadcast for a specific broadcast channel delivered by the broadcast receiver, and sends the generated mobile broadcast reception termination information to the broadcast receiver through communication means (e.g., wired/wireless Internet, Bluetooth) which is connected thereto in a wired or wireless manner and configured to be able to perform bidirectional communication at step S410.

The broadcast receiver stops the delivery of the mobile broadcast for the specific broadcast channel based on the mobile broadcast reception termination information at step S420.

Meanwhile, the broadcast receiver may stop the delivery of mobile broadcast according to the following method without receiving the mobile broadcast reception termination information from the terminal.

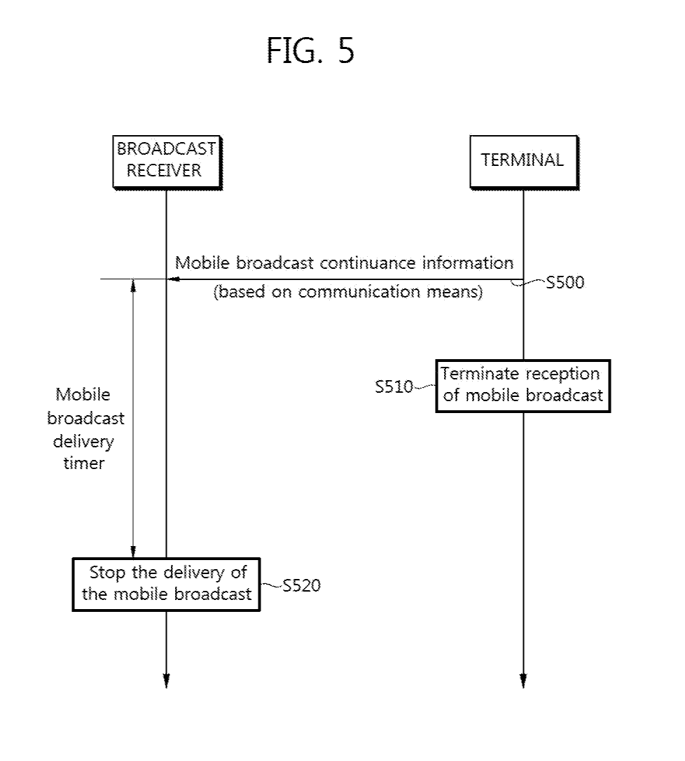

FIG. 5 is a flowchart illustrating an operation in which the broadcast receiver stops the delivery of mobile broadcast by operating a timer in accordance with another embodiment of the present invention. FIG. 5 illustrates an example in which mobile broadcast delivered by the broadcast receiver is mobile broadcast for a specific broadcast channel, but the mobile broadcast delivered by the broadcast receiver may be mobile broadcast for a specific broadcast program in which the mobile broadcast has been recorded.

Referring to FIG. 5, the terminal generates mobile broadcast continuance information, indicating that the terminal continues to receive mobile broadcast for a specific broadcast channel from the broadcast receiver, and sends the generated mobile broadcast continuance information to the broadcast receiver through communication means (e.g., wired/wireless Internet, Bluetooth) which is connected thereto in a wired or wireless manner and configured to be able to perform bidirectional communication at step S500. The mobile broadcast continuance information may be generated periodically or aperiodically and transmitted to the broadcast receiver.

The terminal terminates the reception of the mobile broadcast at step S510. In this case, the terminal may no longer generate the mobile broadcast continuance information or no longer send the mobile broadcast continuance information to the broadcast receiver.

The broadcast receiver operates a mobile broadcast delivery timer. When the mobile broadcast continuance information is received, the broadcast receiver resets the mobile broadcast delivery timer. If the mobile broadcast continuance information is not received for a specific time, the mobile broadcast delivery timer expires. The broadcast receiver stops the delivery of mobile broadcast for the specific broadcast channel at step S520.

Meanwhile, if the broadcast receiver is equipped with a broadcast recording function, such as a Personal Video Recorder (PVR) function, the broadcast receiver may record a specific broadcast program and deliver mobile broadcast for the specific broadcast program to the terminal. For example, if a user wants to view mobile broadcast, but the terminal of the user is not placed within the reception coverage of the mobile broadcast, the user may access the broadcast receiver through a remote access apparatus or through communication means using the terminal and request the broadcast receiver to record a specific broadcast program. Next, when the terminal of the user is placed within the reception coverage of the mobile broadcast, the user may access the broadcast receiver through the communication means using the terminal and request the broadcast receiver to deliver mobile broadcast for the specific recorded broadcast program. When the broadcast receiver delivers the mobile broadcast for the specific recorded broadcast program, the terminal receives the mobile broadcast for the specific recorded broadcast program. Here, the remote access apparatus may be an apparatus, such as the terminal, or may be another device. Furthermore, communication means through which the remote access apparatus is connected to the broadcast receiver may be the same as or different from the communication means through which the terminal is connected to the broadcast receiver. For example, the remote access apparatus and the terminal may be the same smart phone equipped with an Internet access function (or a near field communication function) and a mobile broadcast reception function. For another example, the remote access apparatus may be a Personal Computer (PC) equipped with an Internet access function, and the terminal may be a smart phone equipped with an Internet access function (or a near field communication function) and a mobile broadcast reception function.

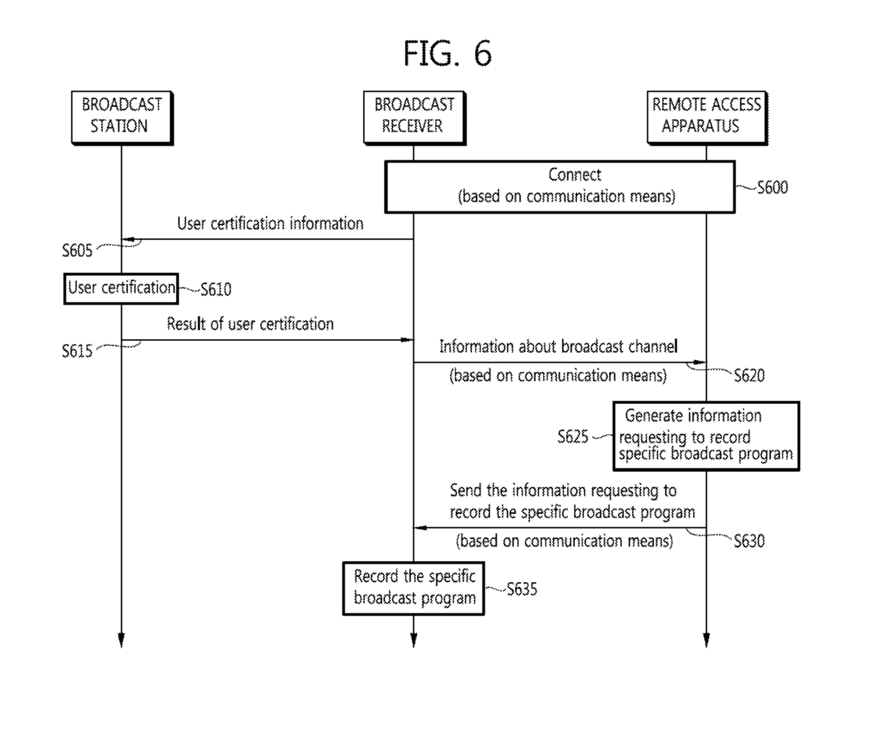

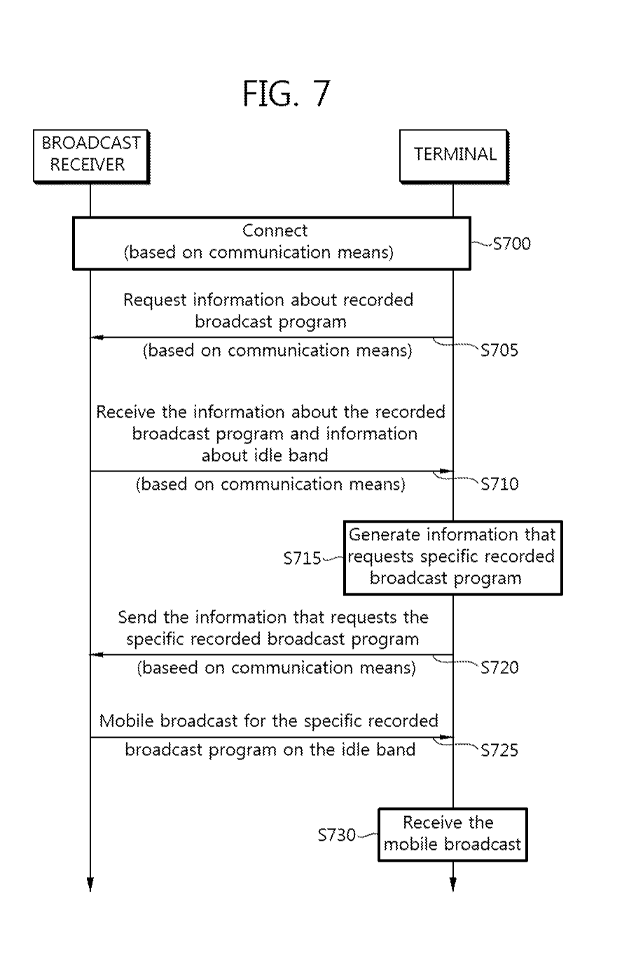

Hereinafter, a process in which the remote access apparatus requests the broadcast receiver to record a broadcast program through the communication means is described in detail with reference to FIG. 6. A process in which the terminal requests the broadcast receiver to deliver mobile broadcast for a recorded broadcast program and receives the mobile broadcast from the broadcast receiver through the communication means is described in detail with reference to FIG. 7.

FIG. 6 shows an example of an operation in which the remote access apparatus requests the broadcast receiver to record a broadcast program in accordance with an embodiment of the present invention.

Referring to FIG. 6, an operation S600 of the remote access apparatus connecting to the broadcast receiver through the communication means, an operation S605 of the broadcast receiver sending user certification information to the broadcast station at need, an operation S610 of the broadcast station performing user certification, and an operation S615 of the broadcast station sending a result of the user certification to the broadcast receiver are performed like the steps S200 to S215 except that the terminal is replaced with the remote access apparatus, and thus a detailed description of the operations S600 to S615 is omitted for simplicity.

The broadcast receiver sends information about a broadcast channel to the remote access apparatus through the communication means at step S620. Here, information about a broadcast channel may be basically information about a channel schedule provided by the broadcast station. If channels that may be provided by the broadcast receiver are limited depending on a user based on a result of the operation S610, information about a broadcast channel may be information about channels that may be provided by the broadcast receiver.

In this case, the broadcast receiver may further send information about an idle channel to the remote access apparatus, but this process is not indispensable.

The remote access apparatus generates information that requests to record a specific broadcast program included in the received information about a broadcast channel at step S625.

The remote access apparatus requests the broadcast receiver to record the specific broadcast program through the communication means at step S630. That is, the remote access apparatus sends the information that requests to record the specific broadcast program to the broadcast receiver.

The broadcast receiver receives the information that requests to record the specific broadcast program and records the specific broadcast program at step S635. That is, the broadcast receiver receives the specific broadcast program from the broadcast station based on the information that requests to record the specific broadcast program and controls the recording of the received specific broadcast program.

FIG. 6 illustrates the operation of the remote access apparatus requesting the broadcast receiver to record the specific broadcast program, but the operations on and by the remote access apparatus may be directly performed by the terminal which receives mobile broadcast from the broadcast receiver. That is, the operation S600 of connecting to the broadcast receiver, the operation S620 of receiving information about a broadcast channel from the broadcast receiver, the operation S625 of generating the information that requests to record the specific broadcast program, and the operation S630 of sending the information that requests to record the specific broadcast program to the broadcast receiver may be performed by the terminal not by the remote access apparatus.

Next, the terminal may receive the specific recorded broadcast program through mobile broadcast. This process may be performed as follows.

FIG. 7 shows an example of an operation in which the terminal requests the broadcast receiver to delivery mobile broadcast for a recorded broadcast program and receives the recorded broadcast program in accordance with an embodiment of the present invention.

Referring to FIG. 7, an operation S700 of the terminal connecting to the broadcast receiver through the communication means is performed like the step S200.

The terminal requests information about a recorded broadcast program from the broadcast receiver at step S705. If the number of recorded broadcast programs is one or more, information about a recorded broadcast program may include information about the plurality of broadcast programs.

The broadcast receiver sends at least one of information about the recorded broadcast program and information about an idle band to the terminal through the communication means at step S710. Here, information about a recorded broadcast program includes information about a specific broadcast program that has been recorded by the broadcast receiver at the request of the remote access apparatus at step S635. If the number of recorded broadcast programs is one or more, information about a recorded broadcast program may include information about the plurality of broadcast programs. Furthermore, the information about an idle band indicates an idle band that has been obtained by the broadcast receiver using a CR method. The broadcast receiver delivers the mobile broadcast on the idle band. The terminal uses the idle band when performing Radio Frequency (RF) tuning.

The terminal selects the specific recorded broadcast program to be received based on information about a broadcast channel and information about a recorded broadcast program and generates information that requests to provide the specific recorded broadcast program selected by the terminal at step S715. Next, the terminal sends the information that requests to provide the specific recorded broadcast program, selected by the terminal, to the broadcast receiver through the communication means at step S720.

The broadcast receiver delivers mobile broadcast for the specific recorded broadcast program, selected by the terminal, to the terminal on the idle band at step S725.

The terminal operates in a mobile broadcast reception mode and receives the mobile broadcast delivered by the broadcast receiver on the idle band at step S730. When the mobile broadcast is received, the terminal may output the specific recorded broadcast program using video and audio output means.

FIG. 7 illustrates an example in which the broadcast receiver provides the terminal with information about a specific recorded broadcast program at the request of the terminal. In some embodiments, the broadcast receiver may provide the terminal with information about a specific recorded broadcast program along with information about a broadcast channel, and the terminal may receive information about a specific recorded broadcast program along with information about a broadcast channel.

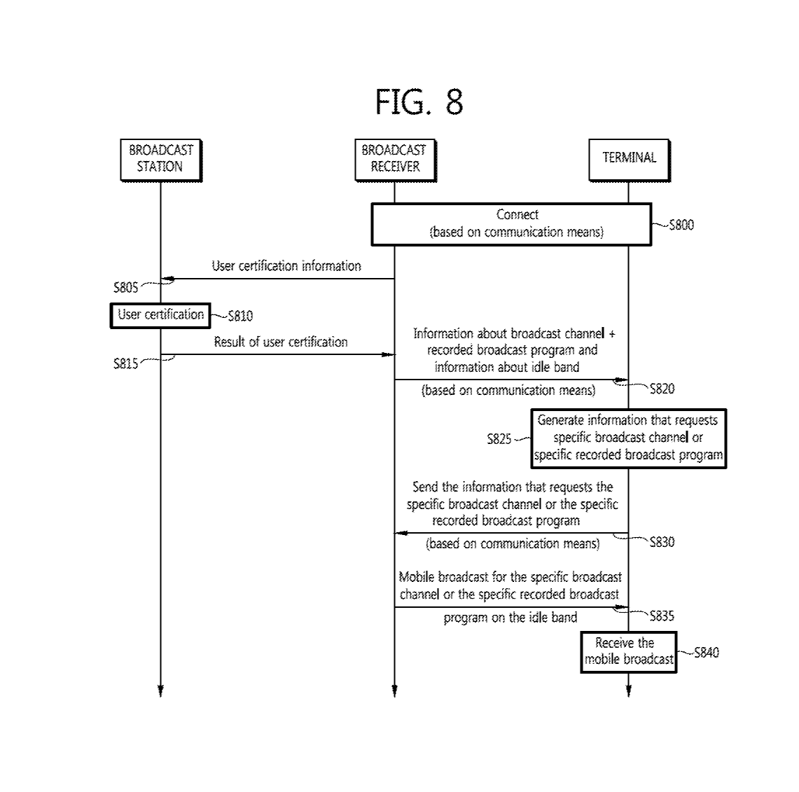

FIG. 8 shows another example of the operation in which the terminal requests the broadcast receiver to deliver mobile broadcast for a recorded broadcast program and receives the recorded broadcast program in accordance with an embodiment of the present invention.

Referring to FIG. 8, an operation S800 of the terminal connecting to the broadcast receiver through the communication means, an operation S805 of the broadcast receiver sending user certification information to the broadcast station, an operation S810 of the broadcast station performing user certification, and an operation S815 of the broadcast station sending a result of the user certification to the broadcast receiver are performed like the steps S200 to S215, and thus a detailed description of the operations S800 to S815 is omitted for simplicity.

The broadcast receiver sends at least one of information about a broadcast channel, information about a recorded broadcast program, and information about an idle band to the terminal through the communication means at step S820. Here, information about a broadcast channel may be basically information about a channel schedule provided by the broadcast station. If channels that may be provided by the broadcast receiver are limited depending on a user based on a result of the operation S810, information about a broadcast channel may be information about channels that may be provided by the broadcast receiver. Furthermore, information about a recorded program is information about a broadcast program that has been recorded by the broadcast receiver at the request of the remote access apparatus at step S635. Furthermore, the information about an idle band has been obtained by the broadcast receiver using a CR method. The idle band is a band on which the broadcast receiver will deliver mobile broadcast. The terminal uses the idle band when performing Radio Frequency (RF) tuning.

The terminal selects a specific broadcast channel to be received or a specific recorded broadcast program based on information about a broadcast channel and information about a recorded program and generates information that requests to provide the specific broadcast channel or the specific recorded broadcast program at step S825. The terminal sends the information that requests to provide the specific broadcast channel or the specific recorded broadcast program to the broadcast receiver through the communication means at step S830.

The broadcast receiver delivers mobile broadcast for the specific broadcast channel or the specific recorded broadcast program on the idle band at step S835.

The terminal operates in a mobile broadcast reception mode and receives the mobile broadcast, delivered by the broadcast receiver, on the idle band at step S840. When the mobile broadcast is received, the terminal may output the specific broadcast channel or the specific recorded broadcast program using audio and video output means.

Meanwhile, FIG. 6 illustrates an example in which the remote access apparatus accesses the broadcast receiver through communication means and requests the broadcast receiver to record a broadcast program. In some embodiments, the remote access apparatus may directly access the broadcast station through communication means and requests the broadcast station to record a broadcast program. A method of the remote access apparatus requesting a broadcast station to record a broadcast program may be performed using a variety of methods, such as using the webpage of the broadcast station or an App provided by the broadcast station. A broadcasting company may perform user certification and then transfer information that requests to record a specific broadcast program to the broadcast receiver. Particularly, the operation of the remote access apparatus requesting the broadcast station to record a broadcast program may be performed as follows.

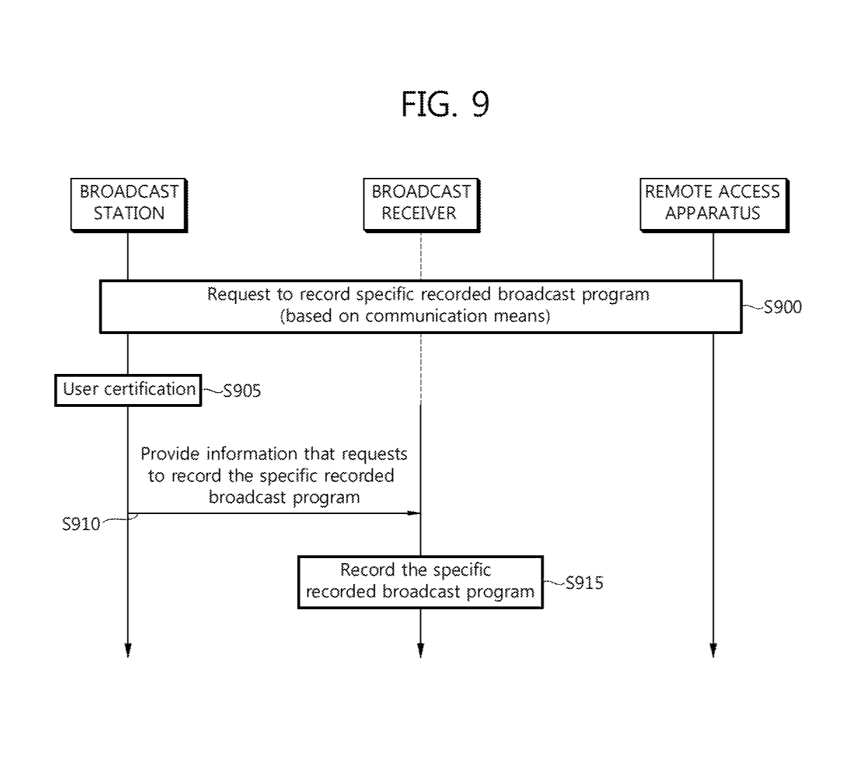

FIG. 9 shows an example of an operation in which the remote access apparatus requests the broadcast station to record a broadcast program in accordance with an embodiment of the present invention.

The remote access apparatus requests the broadcast station to record a specific broadcast program through communication means at step S900. More particularly, the remote access apparatus is connected to the broadcast station through the communication means. The remote access apparatus generates information that requests to record the specific broadcast program and sends the generated information to the broadcast station.

The broadcast station performs user certification at step S905. The user certification includes the contents described at step S210.

FIG. 9 illustrates an example in which the step S900 is performed ahead of the step S905, but the step S905 may be performed ahead of the step S900.

The broadcast station transfers the information that requests to record the specific broadcast program to the broadcast receiver at step S910.

The broadcast receiver records the specific broadcast program at step S915. In this case, the broadcast receiver may start recording the specific broadcast program when the specific broadcast program is received from the broadcast station.

FIG. 9 illustrates the operation of the remote access apparatus requesting the broadcast station to record a specific broadcast program. The operations on and by the remote access apparatus may be directly performed by the terminal which receives mobile broadcast from the broadcast receiver. That is, the operation S900 of requesting the broadcast station to record the specific broadcast program may be performed by the terminal not by the remote access apparatus.

Next, the terminal may receive the specific recorded broadcast program from the broadcast receiver through mobile broadcast. An operation of receiving the specific recorded broadcast program through the mobile broadcast is included in the contents described with reference to FIGS. 7 and 8.

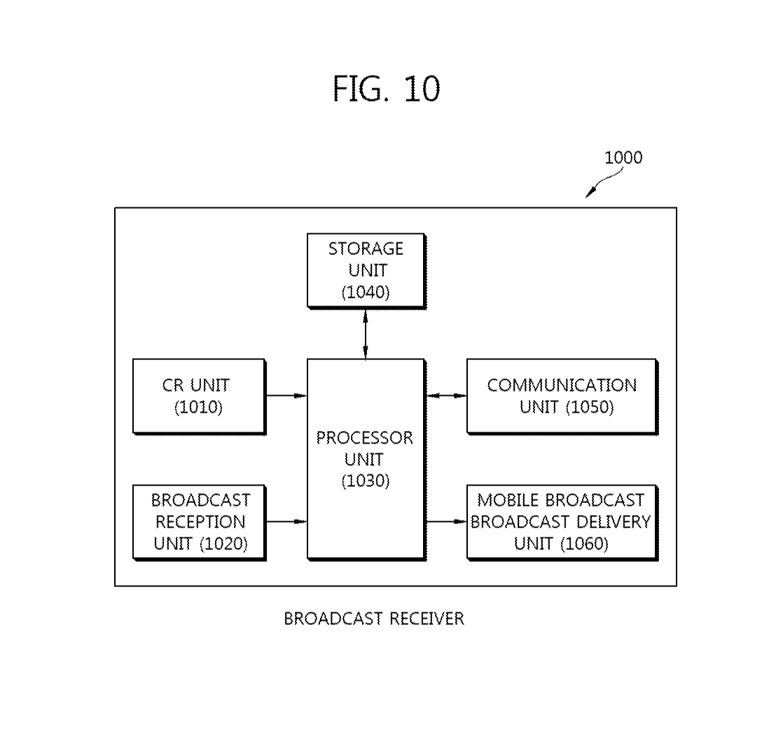

FIG. 10 is a block diagram of the broadcast receiver configured to deliver mobile broadcast in accordance with an embodiment of the present invention.

Referring to FIG. 10, the broadcast receiver 1000 includes a Cognitive Radio (CR) unit 1010, a broadcast reception unit 1020, a processor unit 1030, a storage unit 1040, a communication unit 1050, and a mobile broadcast delivery unit 1060.

The CR unit 1010 detects and monitors an idle frequency band (i.e., an idle band) on which mobile broadcast can be delivered using a CR method and provides the processor unit 1030 with a result of the detection and monitoring of an idle band.

The broadcast reception unit 102 may receive one or more broadcast channels from a broadcast station. The broadcast reception unit 1020 receives a specific broadcast channel or broadcasting content, including a specific broadcast program, from a broadcast station. The broadcast reception unit 1020 may further receive information about a broadcast channel from the broadcast station. The information about a broadcast channel may be basically information about a channel schedule that is provided by the broadcast station. If channels that may be provided by the broadcast receiver 1000 are limited depending on a user or a terminal, information about a broadcast channel may be information about channels that may be provided by the broadcast receiver 1000.

The processor unit 1030 generates information about an idle band based on a result of the detection and monitoring of an idle band which has been received from the CR unit 1010. The processor unit 1030 obtains information about a broadcast channel from the broadcast reception unit 1020. The processor unit 1030 may transfer the information about an idle band and information about a broadcast channel to the storage unit 1040.

Furthermore, the processor unit 1030 may receive at least one of the information about an idle band and information about a broadcast channel which are stored in the storage unit 1040 and transfer the received information to the communication unit 1040. In some embodiments, the processor unit 1030 may receive a result of the detection and monitoring of an idle band from the CR unit 1010 and directly transfer the result to the communication unit 1050, and the processor unit 1030 may receive information about a broadcast channel from the broadcast reception unit 1020 and directly transfer the received information to the communication unit 1050.

Furthermore, the processor unit 1030 may receive information that requests to provide a specific broadcast channel of one or more broadcast channels, included in information about a broadcast channel, from the communication unit 1050. The processor unit 1030 may select the specific broadcast channel from one or more broadcast channels, received by the broadcast reception unit 1020, based on the information that requests to provide the specific broadcast channel and may transfer the selected specific broadcast channel to the mobile broadcast delivery unit 1060.

Furthermore, when information that requests to record a broadcast program is received from the communication unit 1050, the processor unit 1030 may perform control so that the corresponding broadcast program received from the broadcast reception unit 1020 is stored in the storage unit 1040.

The communication unit 1050 functions as means for communicating a terminal or a remote access apparatus. The communication unit 1050 sends at least one of information about a broadcast channel and information about an idle band to the terminal or the remote access apparatus through communication means. Here, the terminal and the remote access apparatus may be the same or different from each other as described above. Furthermore, the communication unit 1050 receives information that requests to provide a specific broadcast channel of one or more broadcast channels, included in information about a broadcast channel, from the terminal.

Furthermore, when information that requests to record a specific broadcast program is received from the remote access apparatus, the broadcast station, or the terminal, the communication unit 1050 transfers the information that requests to record the broadcast program to the processor unit 1030.

Furthermore, when information that requests to provide a specific broadcast channel or information that requests to provide a specific recorded broadcast program is received from the terminal, the communication unit 1050 transfers the request information to the processor unit 1030. In response to the request information, the processor unit 1030 may select or obtain the specific broadcast channel received by the broadcast reception unit 1020, transfer the selected or obtained broadcast channel to the mobile broadcast delivery unit 1060 or convert the selected or obtained broadcast channel into a signal suitable for mobile broadcast, and then transfer the signal to the mobile broadcast delivery unit 1060. In some embodiments, the processor unit 1030 may load the specific recorded broadcast program from the storage unit 1040 and transfer the loaded broadcast program to the mobile broadcast delivery unit 1060 or convert the loaded broadcast program into a signal suitable for mobile broadcast, and then transfer the signal to the mobile broadcast delivery unit 1060.

The mobile broadcast delivery unit 1060 performs signal processing so that a signal suitable for mobile broadcast from the processor unit 1030 can be delivered on an idle band. Furthermore, the mobile broadcast delivery unit 1060 delivers mobile broadcast for the specific recorded broadcast program or the specific broadcast channel on the idle band.

Furthermore, the communication unit 1050 may receive mobile broadcast reception termination information from the terminal. In this case, the communication unit 1050 transfers the mobile broadcast reception termination information to the processor unit 1030. The processor unit 1030 stops the transfer of the specific broadcast channel (or the specific recorded broadcast program) based on the mobile broadcast reception termination information and instructs the stop of the delivery of the mobile broadcast to the mobile broadcast delivery unit 1060. In this case, the mobile broadcast delivery unit 1060 stops the delivery of the mobile broadcast based on the instructed delivery stop.

In some embodiments, the communication unit 1050 may receive mobile broadcast continuance information from the terminal. The mobile broadcast continuance information may be received periodically or aperiodically. In this case, the communication unit 1050 transfers the mobile broadcast continuance information to the processor unit 1030. The processor unit 1030 operates in the mobile broadcast delivery timer and resets the mobile broadcast delivery timer when the mobile broadcast continuance information is received. If the mobile broadcast continuance information is not received until the mobile broadcast delivery timer expires, the processor unit 1030 stops the transfer of the specific broadcast channel (or the specific recorded broadcast program) and instructs to stop the delivery of the mobile broadcast to the mobile broadcast delivery unit 1060. In this case, the mobile broadcast delivery unit 1060 stops the delivery of the mobile broadcast based on the instructed delivery stop.

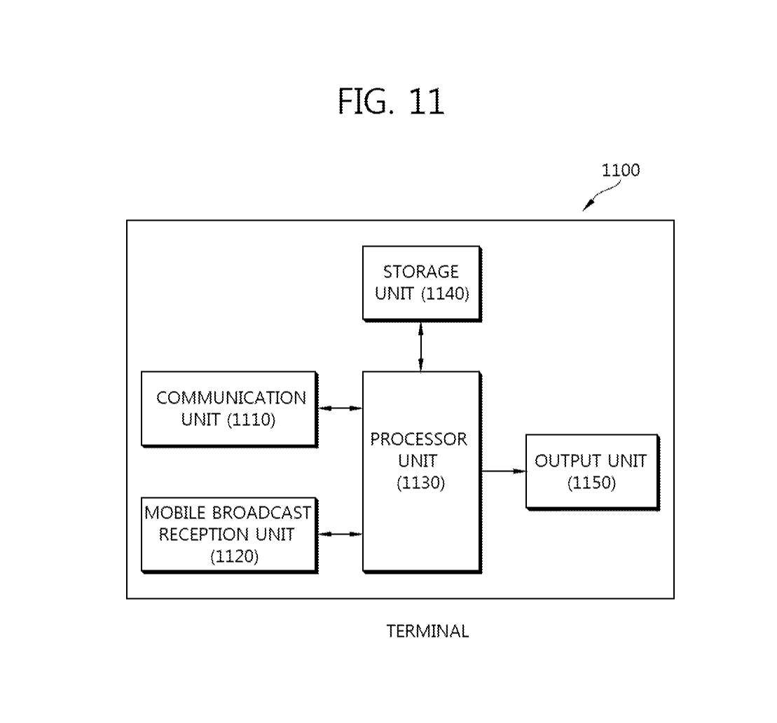

FIG. 11 is a block diagram of the terminal configured to receive mobile broadcast in accordance with an embodiment of the present invention.

Referring to FIG. 11, the terminal 1100 includes a communication unit 1110, a mobile broadcast reception unit 1120, a processor unit 1130, a storage unit 1140, and an output unit 1150.

The communication unit 1110 functions as means for communication with the broadcast receiver and/or the broadcast station. The communication unit 1110 receives at least one of information about a broadcast channel and information about an idle band from the broadcast receiver through communication means. The communication unit 1110 transfers at least one of the received information about a broadcast channel and the received information about an idle band to the processor unit 1130. The processor unit 1130 may generate information that requests to provide a specific broadcast channel of one or more broadcast channels included in information about a broadcast channel. The communication unit 1110 may send the information that requests to provide the specific broadcast channel to the broadcast receiver. Furthermore, the processor unit 1130 may transfer at least one of the received information about a broadcast channel and the received information about an idle band to the storage unit 1140. The storage unit 1140 may store at least one of the received information about a broadcast channel and the received information about an idle band and transfer the received information to the processor unit 1130 at the request of the processor unit 1130.

Furthermore, the communication unit 1110 may send information that requests to record a specific broadcast program to the broadcast receiver or the broadcast station. Furthermore, the communication unit 1110 may send the information that requests to provide the specific recorded broadcast program to the broadcast receiver. The processor unit 1130 may generate the information that requests to record the specific broadcast program. Furthermore, the processor unit 1130 may generate the information that requests to provide the specific recorded broadcast program.

Furthermore, the communication unit 1110 may send information that requests information about a recorded broadcast program to the broadcast receiver. The processor unit 1130 may generate the information that requests information about a recorded broadcast program to the broadcast receiver. Furthermore, the communication unit 1110 may receive information about a recorded broadcast program from the broadcast receiver. The processor unit 1130 may select the specific recorded broadcast program based on information about a recorded broadcast program. The process of selecting the specific recorded broadcast program may be performed based on a user interface. Furthermore, the processor unit 1130 may transfer the received information about a specific recorded broadcast program to the storage unit 1140. The storage unit 1140 may store the received information about a specific recorded broadcast program and transfer the received information to the processor unit 1130 at the request of the processor unit 1130.

Furthermore, the communication unit 1110 may send the information that requests to provide the specific broadcast channel or the information that requests to a specific recorded broadcast program to the broadcast receiver. The two pieces of request information are generated by the processor unit 1130 and transferred to the communication unit 1110.

The mobile broadcast reception unit 1120 receives mobile broadcast for the specific broadcast channel or mobile broadcast for the specific recorded broadcast program which is delivered by the broadcast receiver. The processor unit 1130 performs control based on the information about an idle band so that the mobile broadcast reception unit 1120 receives the mobile broadcast on the idle band. The mobile broadcast reception unit 1120 transfers the received mobile broadcast signal to the processor unit 1130, and the processor unit 1130 processes the mobile broadcast signal and transfers the processed signal to the output unit 1150. The output unit 1150 outputs the processed mobile broadcast signal through audio and video output means.

Furthermore, if it is sought to terminate the reception and output of the mobile broadcast (e.g., a user terminates the viewing of the mobile broadcast), the processor unit 1130 may generate mobile broadcast reception termination information and transfer the generated information to the communication unit 1110. In this case, the communication unit 1110 sends the mobile broadcast reception termination information to the broadcast receiver. The broadcast receiver may stop the delivery of the mobile broadcast based on the mobile broadcast reception termination information.

Furthermore, the processor unit 1130 may generate mobile broadcast continuance information, indicating that the terminal 1100 continues to receive mobile broadcast, to the terminal 1100 periodically or aperiodically. The processor unit 1130 may transfer the mobile broadcast continuance information to the communication unit 1110, and the communication unit 1110 may send the mobile broadcast continuance information to the broadcast receiver 1000. The broadcast receiver 1000 may stop the delivery of the mobile broadcast as described above if it does not receive the mobile broadcast continuance information for a specific time.

In accordance with the above-described methods, the terminal equipped with the mobile broadcast reception function can receive mobile broadcast, such as DMB, and a user can additionally view numerous broadcast channels and broadcast programs, transmitted through cable/IPTV/satellite broadcast stations, through the mobile broadcast reception function. Furthermore, if the broadcast receiver includes a broadcast recording function, such as a PVR function, a user may request to record desired broadcast programs remotely and view a recorded broadcast program using a mobile broadcast reception method, such as DMB. Accordingly, the number of channels and broadcast programs that may be viewed by a user through a terminal equipped with the mobile broadcast reception function, such as DMB, can be significantly increased.

While the exemplary embodiments of the present invention have been described with reference to the accompanying drawings, those skilled in the art may change and modify the present invention in various ways without departing from the essential characteristic of the present invention. Accordingly, the disclosed embodiments should not be construed to limit the technical spirit of the present invention, but should be construed to illustrate the technical spirit of the present invention. The scope of the technical spirit of the present invention is not limited by the embodiments, and the scope of the present invention should be interpreted based on the following appended claims. Accordingly, the present invention should be construed to cover all modifications or variations induced from the meaning and scope of the appended claims and their equivalents.

What is claimed is:

1. A broadcast receiver configured to deliver mobile broadcast, comprising:
a Cognitive Radio (CR) unit configured to detect an idle band using a CR method;
a communication unit configured to send at least one of information about a broadcast channel and information about the idle band to a terminal and receive information, requesting to provide a specific broadcast channel of one or more broadcast channels included in information about a broadcast channel, from the terminal;
a broadcast reception unit configured to receive the one or more broadcast channels from a broadcast station;
a processor unit configured to select the specific broadcast channel from the one or more broadcast channels based on the information requesting to provide the specific broadcast channel and transfer the selected broadcast channel to a mobile broadcast delivery unit; and
a mobile broadcast delivery unit configured to deliver mobile broadcast for the specific broadcast channel on the idle band.

2. The broadcast receiver of claim 1, wherein:
the communication unit receives information, requesting to record a specific broadcast program, from a remote access apparatus, the broadcast station, or the terminal and receives the information requesting to provide the specific recorded broadcast channel from the terminal,
the broadcast reception unit receives the specific broadcast program from the broadcast station,
the processor unit performs control the recording of the received specific broadcast program and selects the specific recorded broadcast program, and
the mobile broadcast delivery unit delivers mobile broadcast for the specific recorded broadcast program on the idle band.

3. The broadcast receiver of claim 2, wherein the communication unit receives information, requesting information about the specific recorded broadcast program, from the terminal and sends information about a recorded broadcast program to the terminal.

4. The broadcast receiver of claim 1, wherein:
the communication unit receives mobile broadcast reception termination information, indicating that the terminal has terminated the reception of the mobile broadcast, from the terminal,
the processor unit stops the transfer of the specific broadcast channel based on the mobile broadcast reception termination information and instructs the mobile broadcast delivery unit to stop the delivery of the mobile broadcast, and
the mobile broadcast delivery unit stops the delivery of the mobile broadcast based on the instructed delivery stop.

5. The broadcast receiver of claim 1, wherein:
the communication unit receives mobile broadcast continuance information, indicating that the terminal continues to receive the mobile broadcast, periodically or aperiodically from the terminal,
the processor unit operates a mobile broadcast delivery timer, resets the mobile broadcast delivery timer if the mobile broadcast continuance information is received, stops the transfer of the specific broadcast channel if the mobile broadcast continuance information is not received until the mobile broadcast delivery timer expires, and instructs the mobile broadcast delivery unit to stop the delivery of the mobile broadcast, and
the mobile broadcast delivery unit stops the delivery of the mobile broadcast based on the instructed delivery stop.

6. A terminal configured to receive mobile broadcast, comprising:
a communication unit configured to receive at least one of information about a broadcast channel and information about an idle band from a broadcast receiver and send information, requesting the broadcast receiver to provide a specific broadcast channel of one or more broadcast channels included in the received information about the broadcast channel, to the broadcast receiver;
a processor unit configured to generate the information requesting to provide the specific broadcast channel; and
a mobile broadcast reception unit configured to receive mobile broadcast for the specific broadcast channel from the broadcast receiver.

7. The terminal of claim 6, wherein:
the processor unit generates information requesting to record the specific broadcast program,
the communication unit sends the information, requesting to record the specific broadcast program, to the broadcast receiver or the broadcast station and sends information, requesting to provide the specific recorded broadcast program, to the broadcast receiver, and
the mobile broadcast reception unit receives mobile broadcast for the specific recorded broadcast program from the broadcast receiver.

8. The terminal of claim 7, wherein the communication unit sends information about the recorded broadcast program to the broadcast receiver and receives the information about the recorded broadcast program from the broadcast receiver.

9. The terminal of claim 6, wherein:
the processor unit generates mobile broadcast reception termination information indicating that the terminal has terminated the reception of the mobile broadcast, and
the communication unit sends the generated mobile broadcast reception termination information to the broadcast receiver.

10. The terminal of claim 6, wherein:
the processor unit generates mobile broadcast continuance information, indicating that the terminal continues to receive the mobile broadcast, periodically or aperiodically, and
the communication unit sends the generated mobile broadcast continuance information to the broadcast receiver.

11. A method of a terminal receiving mobile broadcast, the method comprising:
receiving at least one of information about a broadcast channel and information about an idle band from a broadcast receiver;
sending information, requesting the broadcast receiver to provide a specific broadcast channel of one or more broadcast channels included in the received information about the broadcast channel, to the broadcast receiver;
generating the information requesting to provide the specific broadcast channel; and
receiving mobile broadcast for the specific broadcast channel from the broadcast receiver.

12. The method of claim 11, further comprising:
requesting to record the specific broadcast program;
sending the information, requesting to record a specific broadcast program, to the broadcast receiver or the broadcast station and sends information, requesting to provide the specific recorded broadcast program, to the broadcast receiver; and
receiving mobile broadcast for the specific recorded broadcast program from the broadcast receiver.

13. The method of claim 12, further comprising:
sending information about the recorded broadcast program to the broadcast receiver; and
receiving the information about the recorded broadcast program from the broadcast receiver.

14. The method of claim 11, further comprising:
generating mobile broadcast reception termination information indicating that the terminal has terminated the reception of the mobile broadcast; and
sending the generated mobile broadcast reception termination information to the broadcast receiver.

15. The method of claim 11, further comprising:
periodically or aperiodically generating mobile broadcast continuance information indicating that the terminal continues to receive the mobile broadcast; and
sending the generated mobile broadcast continuance information to the broadcast receiver.
